(19) United States
(12) Patent Application Publication
(10) Pub. No.: US 2011/0016386 A1
(43) Pub. Date: Jan. 20, 2011

(54) INFORMATION PROCESSING DEVICE WHICH CONTROLS DISPLAY OF SUMMARIES AND PREVIEWS OF CONTENT OF COLUMNS IN WEB CONTENT DEPENDING ON DISPLAY AREA SIZES, AND RECORDING MEDIUM WHICH RECORDS CONTROL PROGRAM THEREOF

(75) Inventors: Wakana Odagiri, Tachikawa-shi (JP); Hideyuki Toriumi, Koshigaya-shi (JP)

Correspondence Address: TUROCY & WATSON, LLP, 127 Public Square, 57th Floor, Key Tower, CLEVELAND, OH, 44114, US

(73) Assignee: CASIO COMPUTER CO., LTD., Tokyo (JP)

(21) Appl. No.: 12/834,214

(22) Filed: Jul. 12, 2010

(30) Foreign Application Priority Data
Jul. 17, 2009 (JP) 2009-169121

(51) Int. Cl. G06F 17/00

(52) U.S. Cl. 715/243; 715/273

(57) ABSTRACT

When an information processing device expands and displays a received web content item into a web page, the device analyzes the received web content item and extracts columns respectively as constitutive units forming a layout of the web page, compares each of display areas of the columns with a threshold, in a display state of the web page by a display device, and thereby determines whether each of the display areas is sufficient or not. If the display area of any of the columns is not sufficient as a result determined, the information processing device summarizes content of the any of the columns, depending on the display area, adapts summarized content of the any of the column into a preview display format depending on the display area, and displays the adapted content on the display device.

### CROSS-REFERENCE TO RELATED APPLICATIONS

This application is based upon and claims the benefit of priority from prior Japanese Patent Application No. 2009-169121, filed Jul. 17, 2009, the entire contents of which are incorporated herein by reference.

### BACKGROUND OF THE INVENTION

1. Field of the Invention

The present invention relates to an information processing device for browsing/displaying web content items and also to a recording medium which records a control program thereof.

2. Description of the Related Art

Conventionally, in server-client systems for communication networks such as Local Area Network (LAN), Wide Area Network (WAN), and the Internet, various web content items generated and stored by server devices are obtained and displayed or, namely browsed by web browsers comprised in client devices.

In general, web content items are written in Hyper Text Markup Language (HTML). Document structures of the web content items are analyzed by web browsers to display the content items as web pages.

In recent years, development of various devices involves increase of opportunities to browse web content items from terminals other than personal computers (PCs), such as mobile terminals and digital consumer electronics. However, presently existing web content items are mostly prepared for PCs. Such PC-oriented web content items are demanded to be comfortably browsed by the aforementioned terminals other than PCs. However, physical limitations to those terminals, such as differences in screen size and resolution or poor capability of input modules, hinder themselves from operationality and efficiency equivalent to those in browsing environments of PCs mainly using mice.

Hence, an information display device has been conceived of, which can improve accessibility to link destinations even in mobile terminals by displaying an optional list which is independent from a content item (for example, see Jpn. Pat. Appln. KOKAI Publication No. 2006-11536). The list cites only links in a web content item by analyzing the web content item.

In the conventional information display device as described above, for example, accessibility to links existing in a web content item can be improved even when the web content item cannot entirely be displayed on one screen. However, such improvement in accessibility cannot contribute to reduction of labor necessitated for browsing the entire web content item. Further, when there are a number of undesired links as in recent web content items, a list of the links is very huge. Particularly in small screens of mobile thermals, a space for independently displaying the huge list of links is difficult to prepare, and accessibility to links deteriorates at the same time.

Further, many of modules for allowing an entire web content item to be comfortably browsed by a mobile terminal, such as full browsers for mobile phones typically represented by Opera (registered trademark), provide a mode for vertically arranging columns in a web content item. In this mode, content items are always displayed, contained within the horizontal width of a screen. Although the user would receive no stress from a content item divided halfway, a required vertical scroll distance increases. Consequently, a problem of limited viewability at a glance is not solved.

As an alternative, there is another trend of trying to compensate for limited viewability at a glance by an excellent zoom function to display content items in the same layout as in PCs, in browsers for smart phones, such as NetFront (registered trademark) Browser.

However, once text is zoomed in up to a easily visible size, peripheral content items cannot be grasped, and therefore, there is not much difference. To ensure visibility at a glance, a content item need be greatly zoomed out. In this state, however, letters are not readable, and whether the content item actually interests the user or not cannot be known before zooming in.

As a result, the user tries to repeatedly zoom in and out depending on a rough guess.

### BRIEF SUMMARY OF THE INVENTION

The present invention has an object of providing an information processing device which allows easy understanding of summaries of content of columns in web content items by reducing complex manipulations and particularly improves convenience of browsing web content items by mobile terminals using a small screen also by reducing complex manipulations, and an object of providing a recording medium which records a control program thereof.

According to a first aspect of embodiments, there is provided an information processing device comprising:

a web content receiver module configured to receive a web content item;

a display module configured to expand and display the received web content item into a web page;

a column extraction module configured to analyze the received web content item and extract columns respectively as constitutive units forming a layout of the web page;

a determination module configured to compare each of display areas of the columns with a threshold, in a display state of the web page by the display module, and thereby determine whether each of the display areas is sufficient or not;

a summarization module configured to, if the display area of any of the columns is not sufficient as a result determined by the determination module, summarize content of the any of the columns, depending on the display area; and

a preview display module configured to, if the display area of any of the columns is not sufficient as a result determined by the determination module, adapt summarized content of the any of the column into a preview display format depending on the display area, and display the adapted content on the display module.

According to a second aspect of embodiments, there is provided an information processing device comprising:

a web content receiver module configured to receive a web content item;

a display module configured to expand and display the received web content item into a web page;

a column extraction module configured to analyze the received web content item and extract columns respectively as constitutive units forming a layout of the web page;

a determination module configured to compare display each of display areas of the columns with a threshold, in a display state of the web page by the display module, and thereby determine whether each of the display areas is sufficient or not;

a summary obtaining module configured to, if the display area of any of the columns is not sufficient as a result determined by the determination module, obtain a summary sentence of an updated part of the any of the columns; and

a preview display module configured to, if the display area of any of the columns is not sufficient as a result determined by the determination module, adapt content of the summary sentence into a preview display format depending on the display area, and display the adapted content on the display module.

According to a third aspect of embodiments, there is provided a non-transitory recording medium which records a program for controlling a computer of an information processing device comprising a display section, the program causing the computer to function as:

a web content receiver module configured to receive a web content item;

a display module configured to expand and display the received web content item into a web page;

a column extraction module configured to analyze the received web content item and extract columns respectively as constitutional units forming a layout of the web page;

a determination module configured to compare display each of display areas of the columns with a threshold, in a display state of the web page by the display module, and thereby determine whether each of the display areas is sufficient or not;

a summarization module configured to, if the display area of any of the columns is not sufficient as a result determined by the determination module, summarize content of the any of the columns, depending on the display area; and

a preview display module configured to, if the display area of any of the columns is not sufficient as a result determined by the determination module, adapt summarized content of the any of the column into a preview display format depending on the display area, and display the adapted content on the display module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate a embodiment of the invention, and together with the general description given above and the detailed description of the embodiment given below, serve to explain the principles of the invention.

FIG. 1 is a block diagram illustrating a configuration of a server-client system according to an embodiment of an information processing device according to the present invention;

FIG. 2 is a block diagram illustrating a circuit configuration of a server device in the server-client system;

FIG. 3 is a block diagram illustrating a circuit configuration of a client device in the server-client system;

FIG. 4 illustrates an example of a web content item obtained from the server device by the client device;

FIG. 5 illustrates a display state in the client device, in which the web content item in FIG. 4 is displayed by an ordinary web browser program;

FIG. 6A is a table representing types of column summaries used for preview-summary content items of web content items;

FIG. 6B is a table representing types of preview UIs for presenting preview-summary content items to the user;

FIG. 7 illustrates an example in which columns in a web content item in FIG. 4 are summarized by a column summary generation method based on “extraction depending on text strength”;

FIG. 8 represents an example of a source of RSS associated with the web content item in FIG. 4;

FIG. 9 illustrates an example in which columns in the web content item in FIG. 4 are summarized by a column summary generation method based on “updated part extraction”;

FIG. 10 illustrates an example of screen transition in which a “font size reduction” UI is employed as a preview UI;

FIG. 11 illustrates an example of screen transition in which a “thumbnail size reduction” UI is employed as a preview UI;

FIG. 12 illustrates an example of screen transition in which an “automatic scrolling” UI is employed as a preview UI;

FIG. 13 illustrates an example of screen transition in which a “balloon” UI is employed as a preview UI;

FIG. 14A is a main flowchart of a web browser program in the client devices;

FIG. 14B is a flowchart representing details of a preview processing for columns in FIG. 14A;

FIG. 15 represents a flowchart of a column summarization processing when preview-summary content items are generated by “extraction depending on text strength”;

FIG. 16 is a graph for describing calculation of background strength points, and represents an example of results of calculating a total of characters for each background in a column;

FIG. 17 is a table representing an example of text strengths respectively for lines; and

FIG. 18 represents a flowchart of the column summarization processing when preview-summary content items are generated by “updated part extraction”.

### DETAILED DESCRIPTION OF THE INVENTION

Hereinafter, an embodiment for practicing the invention will be described with reference to the drawings.

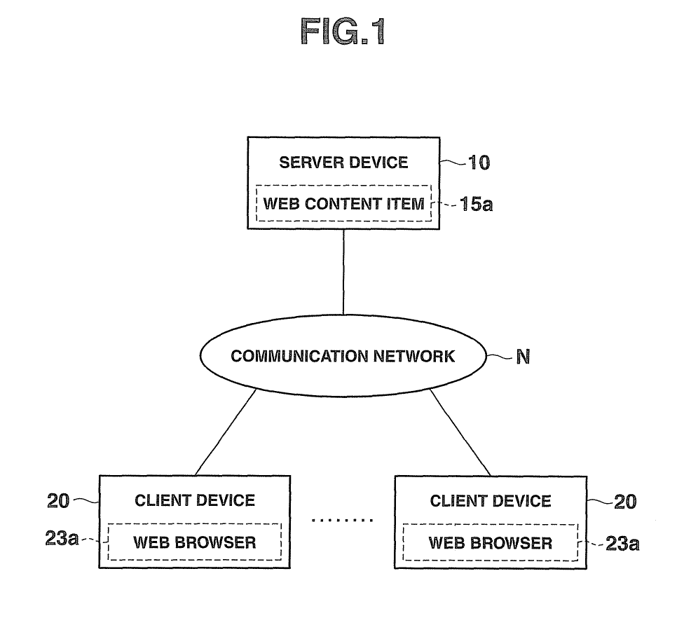

FIG. 1 is a block diagram illustrating a configuration of a server-client system according to an information processing device for an embodiment of the invention.

The server-client system includes a server device 10 and plural client devices 20 each connected to a network N which is constituted by the Internet, WAN, or LAN.

The server device 10 includes plural application programs which function according to manipulations on the main body of the server device 10, such as a web-content generation processing program, a registered-user management processing program, and a web page distribution processing program. For example, in response to an access request for accessing a specified web site from a client device 20 which has been registered by user registration into the server device 10, a page containing a web content item 15a of the requested web site is distributed to the client device 20.

The client devices 20 each are constituted by a mobile phone, Personal Digital Assistant (PDA), or PC, and each includes plural application programs which function in accordance with manipulations on a main body, such as an Internet connection processing program, a web browser program 23a, and a web print program. Further, for example, a client device 20 accesses the server device 10 of a desired web site, and obtains the web content item 15a. The client device 20 further analyzes Hypertext Markup Language (HTML) of the web content item 15a, and divides the content item into columns. The client device 20 generates summaries in units of columns, and displays the summaries so as to comply with a preview display format depending on display areas.

An intermediate server may be entitled to a processing for treating web content items received from the server device 10. For example, web content items may be summarized into columns by a server which relays web content items, such as a proxy server, or by any other external server connected to the client device 20. The columns may then be transferred to the client device 20.

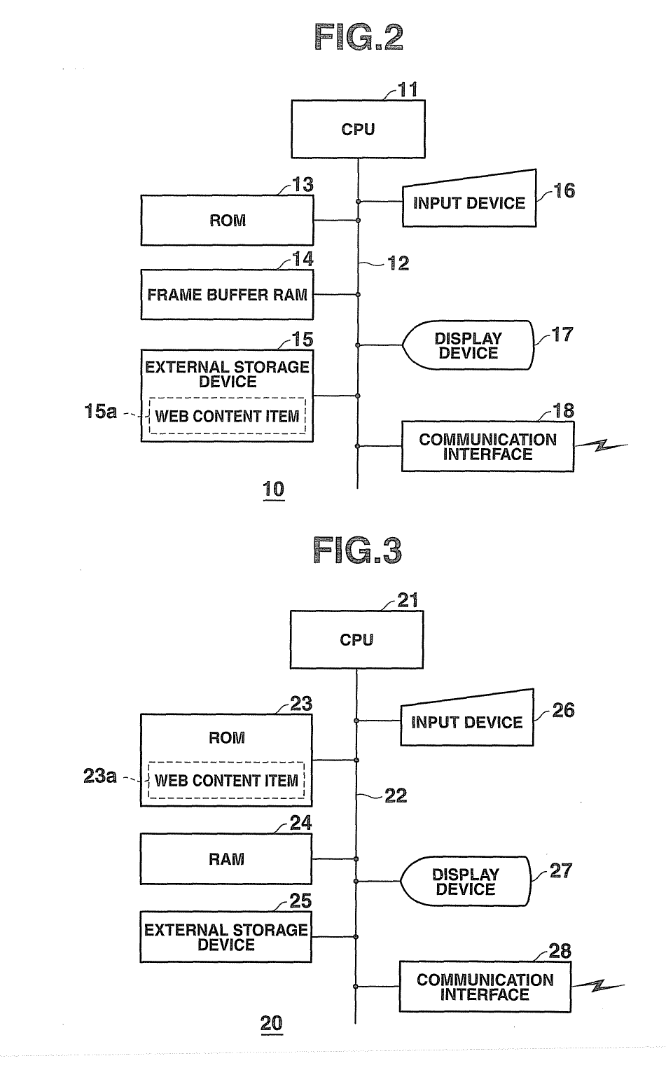

FIG. 2 is a block diagram illustrating a circuit configuration of the server device 10 in the server-client system.

The server device 10 includes a CPU 11 as a computer. The CPU 11 is connected to a ROM 13, a frame buffer RAM 14, and an external storage device 15 such as an external hard disc, through a bus 12.

Further, the CPU 11 is connected through the bus 12 to an input device 16 such as a keyboard or a mouse, a display device 17 such as Liquid Crystal Display (LCD), and a communication interface 18 to the client device 20.

The CPU 11 controls operations of respective sections of circuits, using the frame buffer RAM 14 as a work memory, in accordance with a system program and various application programs which are presorted in the ROM 13. The various programs are started/executed in accordance with key input signals from the input device 16 and web-content obtaining request signals in response to user manipulations, which are received through the communication interface 18 from the client devices 20.

The web content item 15a is, for example, stored, appropriately updated, and newly generated in the external storage device 15.

FIG. 3 is a block diagram illustrating a circuit configuration of a client device 20 in the server-client system.

The client device 20 includes a CPU 21 as a computer. The CPU 21 is connected through a bus 22 to a ROM 23, a RAM 24, and an external storage device 25 such as a memory card or an optical disc read/write section.

Further, the CPU 21 is connected through the bus 22 to an input device 26 such as a keyboard or a mouse, a display device 27 constituted by a LCD, and a communication interface 28.

The CPU 21 controls operations of respective sections of circuits, using the RAM 24 as a work memory, in accordance with a system program and various application programs which are presorted in the ROM 23. The various programs are started and executed in accordance with input signals from the input device 26.

Supposing that the server device 10 is a web site on the Internet (N) and the client device 20 is a user terminal which can access the web site, a web content item 15a written in HTML is distributed to the user terminal (20) as a source of issuing an access request by the web site (10), in response to the access request from the user terminal (20) to the web site (10). The web browser program 23a of the user terminal (20) is expanded into a web page and is displayed on the display device 27.

The web browser program 23a of the client device (user terminal) 20 has a column preview control function to obtain a web content item 15a in response to an access request to the server device 10 of the web site specified by the user, analyze HTML of the web content item 15a, and divide the web content item 15a into columns (as will be described in details later). The column preview control function further functions to generate summaries in units of columns, and display previews of the summaries adapted to preview display formats depending on a display areas. The column preview control function, for example, is established by a program which is plugged in or added on the web browser program 23a.

Hereinafter, the column preview control function of the web browser program 23a in the client device 20 will be described in details.

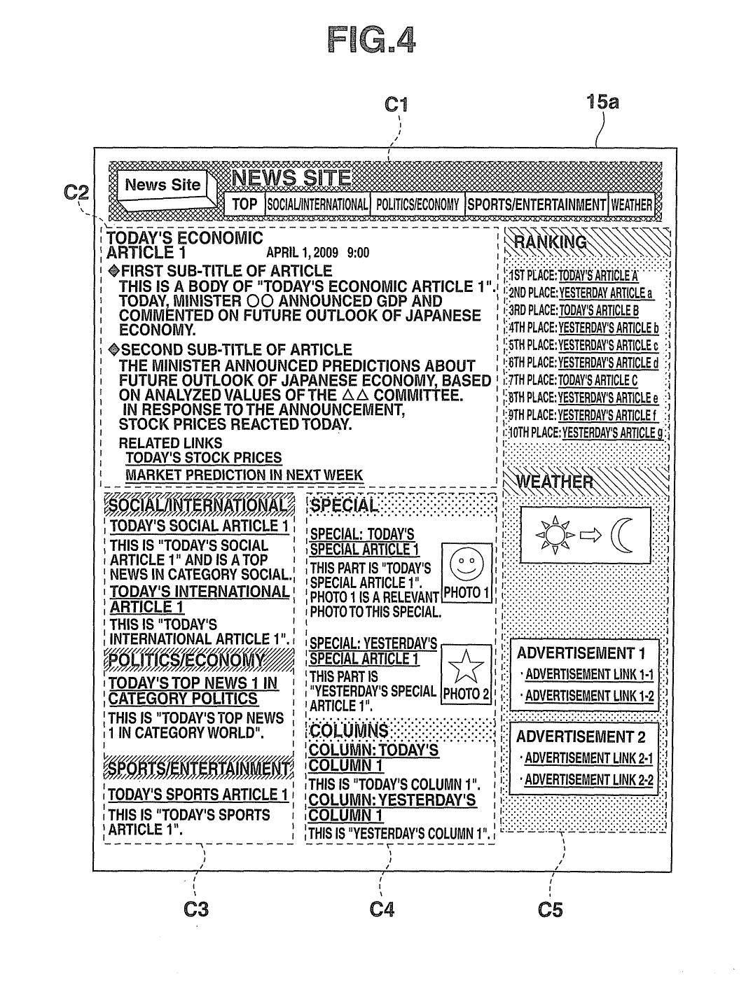

FIG. 4 illustrates an example of the web content item 15a obtained from the server device 10 by the client device 20.

In general, a web content item is constituted by plural different types of parts (e.g., a header, a footer, an article body, a part for guiding users to links, etc.) These sectioned parts are referred to as columns. The web content item 15a exemplified in FIG. 4 includes five columns C1 to C5.

Processing for extracting and dividing columns in the web browser program 23a of the client device 20 can be constituted by existing methods such as methods adopted in a full browser Opera (registered trademark) for mobile phones. Therefore, descriptions of this processing will be omitted herefrom.

FIG. 5 illustrates a display where the web content item 15a as illustrated in FIG. 4 is displayed on the display device 27 by a common web browser program.

A display range 27a of a browser window which can be displayed by the display device 27 can only cover a part of the web content item 15a in which parts of columns C2, C3, and C4 are displayed. In this case, a large part of column C2 is displayed. Although lateral parts thereof are more or less cut off, what kind of content the column contains can be distinguished without especially scrolling the window. In contrast, only fragments of columns C3 and C4 are displayed, the user can hardly know what purpose these columns are for and further whether interesting information for the user is contained therein or not.

Hence, the web browser program 23a according to the present embodiment substitutes columns such as columns C3 and C4, displayed parts of which are too narrow, with preview-summary content items from which outlines of the columns can be known. By providing a user interface (UI) which matches preview display, the user can have a total understanding of the whole columns even still in small display areas. Further, as display areas of respective columns are increased or decreased by scrolling or zooming, ratings of summarization of the columns are increased or decreased so that the summaries may not overflow out of the screen.

On the other side, a column which is allocated a sufficient display area, such as column C2, is directly displayed without any processing. Such a column, however, may alternatively be appropriately processed to provide an easy view. For example, a layout may be adjusted depending on a window width, so that whole text can be read without horizontal scrolling.

More specific descriptions will now be given below.

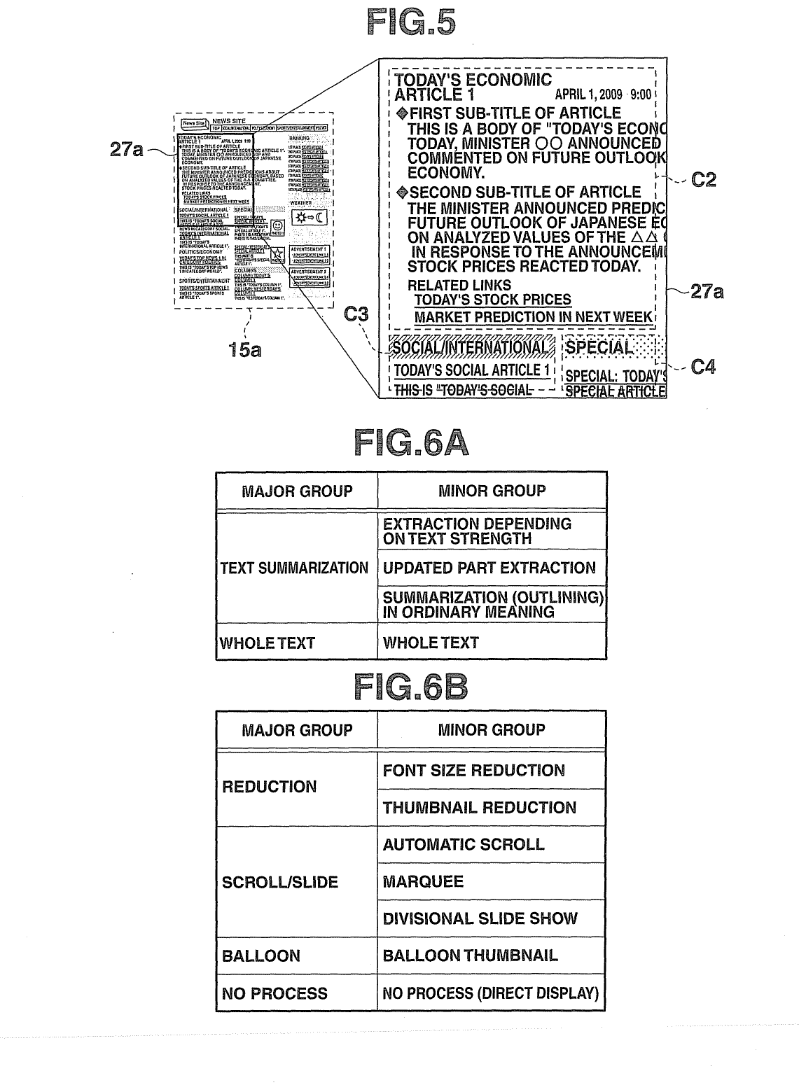

FIG. 6A is a table listing types of column summaries used for preview summary content items. FIG. 6B is a table listing types of preview UIs for presenting preview-summary content items to the user.

As listed in FIG. 6A, column summaries each are generated in form of a “text summary” of text in a column, or in form of “whole text” in a column. Depending on display areas of columns, ratings of column summarization vary. As a display area is narrowed, a rating of summarization is increased, and a shorter column summary is generated.

For a method for generating a text summary, three types are available, e.g., “extraction depending on text strength”, “updated part extraction”, and “summarization (outlining) in ordinary meaning”.

At first, a column-summary generation method based on the “extraction depending on text strength” will be described. This method defines a “text strength”, which increases as text is more outstanding. Lines of text are extracted, prioritizing a column having a greater text strength, to form a summary of the column.

The text strength may be defined, for example, depending on a style of text in lines. The style may include a font size, a font weight (boldness value), and a background. The text strength may be greater as text has a greater outstanding style value owing to a greater font size/weight and a locally different background.

There is a high possibility that more outstanding and stronger text is important text such as a title of an article or a category. Such text is effective as content of a column summary. Therefore, to extract such text locally given priority is a basic concept of this generation method.

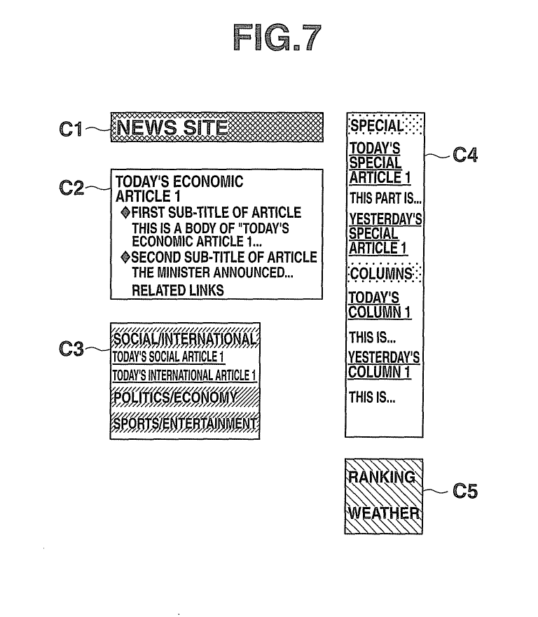

FIG. 7 illustrates an example in which columns in the web content item 15a in FIG. 4 are summarized in accordance with a column-summary generation method based on “division depending on text strength”. A specific processing operation of creating column summaries by the web browser program 23a will be described later.

According to this generation method, only text of “News Site” is extracted from column C1. This line has a greater text strength owing to use of a large font size and a different background from other text.

From column C2, a title and sub-titles which are more outstanding and have greater strengths are extracted. From a text body of the article which has a smaller strength, only a volume of text which can be contained in the screen is extracted from each of heads of lines, and abbreviated parts are substituted with “ . . . ”.

In column C3, a vertical height is shortened while a horizontal width is maintained, and so, only category titles and article titles are contained. In this example, whole text lines, which are appended to article titles and are not bold, cannot be contained in the display area, and are therefore omitted. Further, whole lines of article titles in a later part are omitted due to the short display area.

In column C4, a horizontal width is shortened while a vertical height is maintained. Accordingly, a line feed is adjusted so that text is contained within a display range.

Column C5 is an example of column summarization where a display range is reduced both vertically and horizontally.

Next, a description will be made of the column-summary generation method, based on “updated part extraction”. In this method, only recently updated parts are extracted from columns, and are used to form summaries of the columns.

In news sites and portal sites, old information and permanently presented information have been read or are less worthy. Hence, if only new and worthy information is extracted, the user can quickly determine whether columns are worth seeing minutely.

In the present embodiment, RDF Site Summary (RSS) is used an example of a method for extracting updated parts. RSS is a language for writing resources such as individual pages in a web site, like a catalogue. At present, a RSS is popularly distributed as a catalogue of updated information in each web site or in each category in a web site. Which web page is connected to which RSS is specified by writing a URL of a RSS with use of a <link> tag in a HTML source of the web content item 15a.

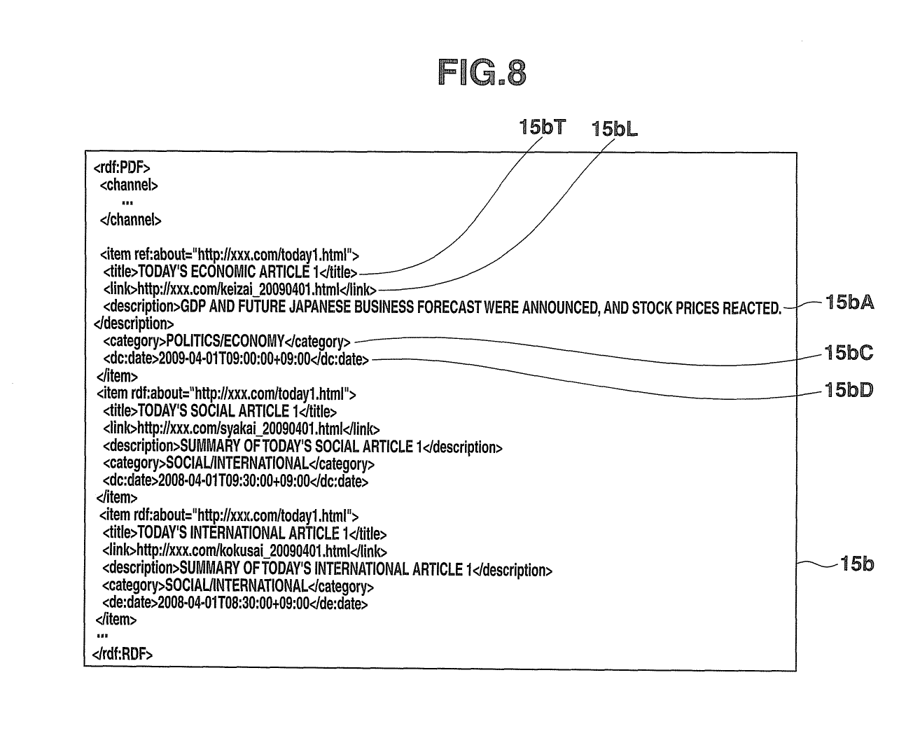

FIG. 8 represents an example of a source 15b of a RSS associated with the web content item 15a in FIG. 4.

As represented in this figure, RSS has a predetermined hierarchical structure in which individual updated information items each of which is written with use of an <item> tag. Written information are: a title 15bT of an updated page which is written with a <title> tag; a URL 15bL of a body of a written article which is written with a <link> tag; a summary 15bA prepared by a web site provider which is written with a <description> tag; a category 15bC is written with a <category> tag; and an updated date/time 15bD written with a <dc:date> tag.

Most of information written in a RSS is mere information telling which of branched pages in a site have been updated (which are not a top page but are body pages containing detailed articles in case of a news site). On the other side, information in a RSS is also scattered in other pages, e.g., titles are used for links to such branched pages. Therefore, by referring to information in a RSS, branched pages written in the RSS or information indicating which parts of other pages linked to the RSS are new can be estimated.

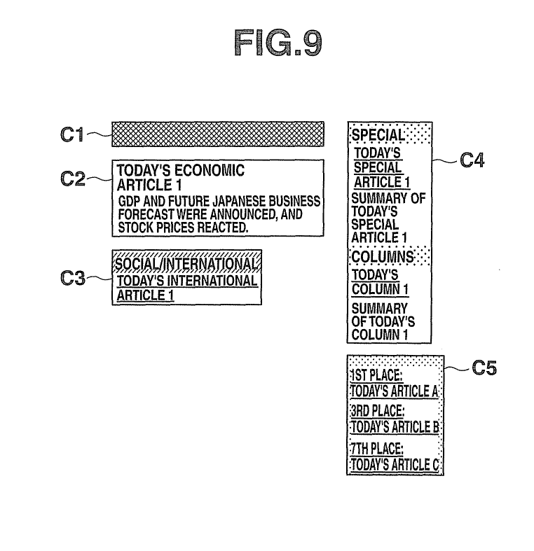

FIG. 9 illustrates an example in which columns in the web content item 15a in FIG. 4 are summarized in accordance with the column-summary generation method based on the “updated part extraction”. That is, this figure represents an example of as a result of extracting updated parts from information in a RSS. A specific processing operation of creating column summaries by the web browser program 23a will be described later.

Column C1 is a part like a guide menu which always suggests fixed information. This part is not related with a RSS at all, i.e., no new article is included in this part. Therefore, according to this generation method, no content item is extracted into column C1.

Column C2 includes a newly arrived article whose title and URL are listed in a RSS. Therefore, a main title (the title 15bT of an updated page) of the article included in the RSS is extracted. Further, a text body of the article located in a lower part of the web content item 15a is substituted with a summary 15bA prepared by a distributor and included in the RSS.

Columns C3 represents an example of using not only the title 15bT in the updated page but also the category 15bC. Category names are often used as titles respectively for categories in the web content item 15a, and are also keywords each of which clearly indicates what is related to a content item included in a column. Though not a newly updated part, a category name is favorable as a content item in a summary.

Further, column C3 includes a number of updated parts and has a very small display range. Therefore, even a summary thereof cannot be contained in the display range. Hence, if the display range is limited, the updated date/time 15bD in the RSS is referred to, and more newly updated content items are extracted prioritized.

Columns C4 and C5 are examples of column summaries which include a link to a yesterday's article whose updated date/time 15bD is old. The old article of yesterday is not extracted since the old yesterday's article has disappeared from the RSS or any other article having newer updated date/time is prioritized.

Further, from column C5, advertising parts not included in the RSS are not extracted but deleted. Thus, use of a RSS provides an effective feature that information which is not related with a web site, such as advertisements, can be excluded.

Although the present embodiment uses a RSS, information written in any other format, such as Atom, can be used insofar as meta-information indicates updated information in the web content item 15a.

Further, the method for extracting updated parts is not limited to a method using distributed update information such as a RSS.

For example, there can be considered a method for finding a difference to a web content item previously stored in the client device 20 at the time of a last visit, another method for making a determination using updated date/time appended to titles as keys, or a still another method for detecting a text string such as “New” or “Update” or an icon image.

Further, only for columns which include no updated parts at all or very few updated parts, like column C1 in FIG. 9, a different method for creating column summaries from the column-summary generation method based on the “updated part extraction” may be combined.

Next, a description will be made of the column-summary generation method based on “summarization (outlining) in ordinary meaning”. This method is to outline sentences or, namely, to summarize sentences in columns in ordinary meaning.

Substance of this ordinary summarization technique may employ existing techniques which do not relate to the subject matter of the present invention. Therefore, descriptions thereof will be omitted herefrom.

As a result of this generation method is represented, for example, as column C2 in FIG. 9.

As an alternative to summaries, only keywords may be automatically picked up from sentences in columns and may be listed.

On the other side, in contrast to the text summarization described above, the ordinary meaning of summarization is substantially lost when “whole text” is used in a column summary used for a preview-summary content item of a web content item. This is a case which does not have an effective meaning before being combined with a preview UI as represented in FIG. 6B.

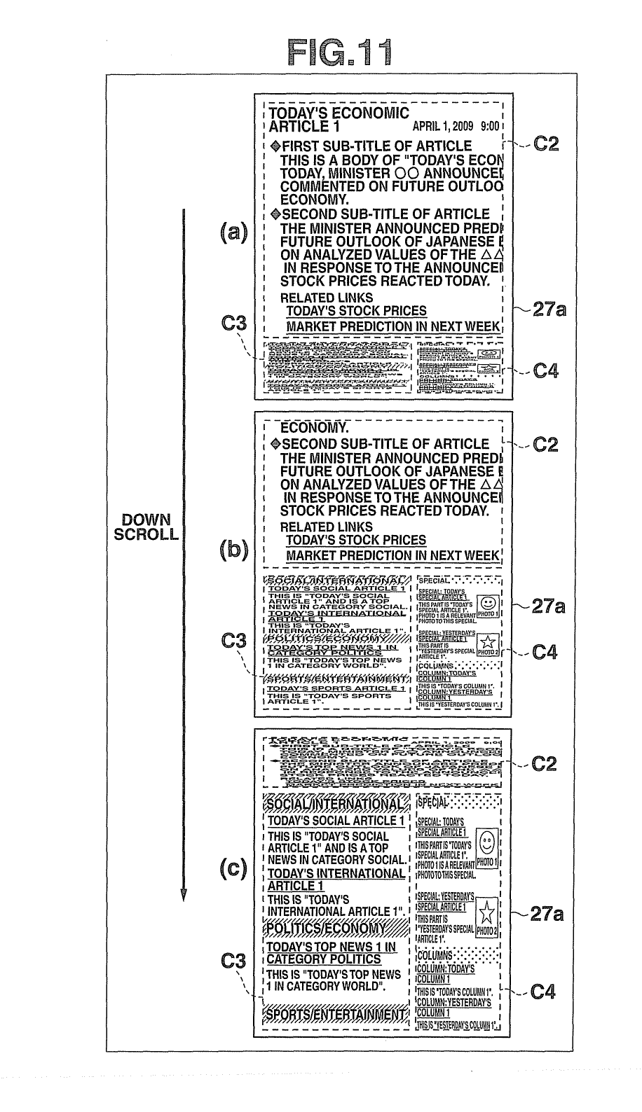

In handling images when a preview summary content item is generated, images in a column may be excluded from a column summary or included with its size reduced in a column summary when a summary content item for previews is generated (images are excluded from the column summary in the example of FIG. 7 and are included in column C4 in the example of FIG. 11). Further, even if images are included, large images may be excluded or only images having a small size like icons may be included.

However, depending on sites, important text is imaged, e.g., images including characters are employed to use elaborate fonts and a backgrounds for titles, or buttons for input forms are expressed as images. To cope with a case as described above, only “wide images having a height equivalent to characters or so” may be included in column summaries.

Next, types of preview UIs for presenting preview-summary content items to the user will be described.

In the present embodiment, preview-summary content items which have been created by creation methods as described above are presented to the user by methods as represented in FIG. 6B. Specifically, there are four presentation types of “size reduction”, “scroll/slide”, “balloon”, and “no process”. Of the four types, the presentation type “size reduction” includes further two types of size reduction methods “font size reduction” and “thumbnail size reduction”. The presentation type “scroll/slide” includes three types of methods “automatic scrolling”, “marquee”, and “divisional slide show”.

These methods need not always be used singly but may be appropriately combined with each other in use, for example, in a combination of “font size reduction”+“automatic scrolling”.

Hereinafter, individual types of preview UIs will be described.

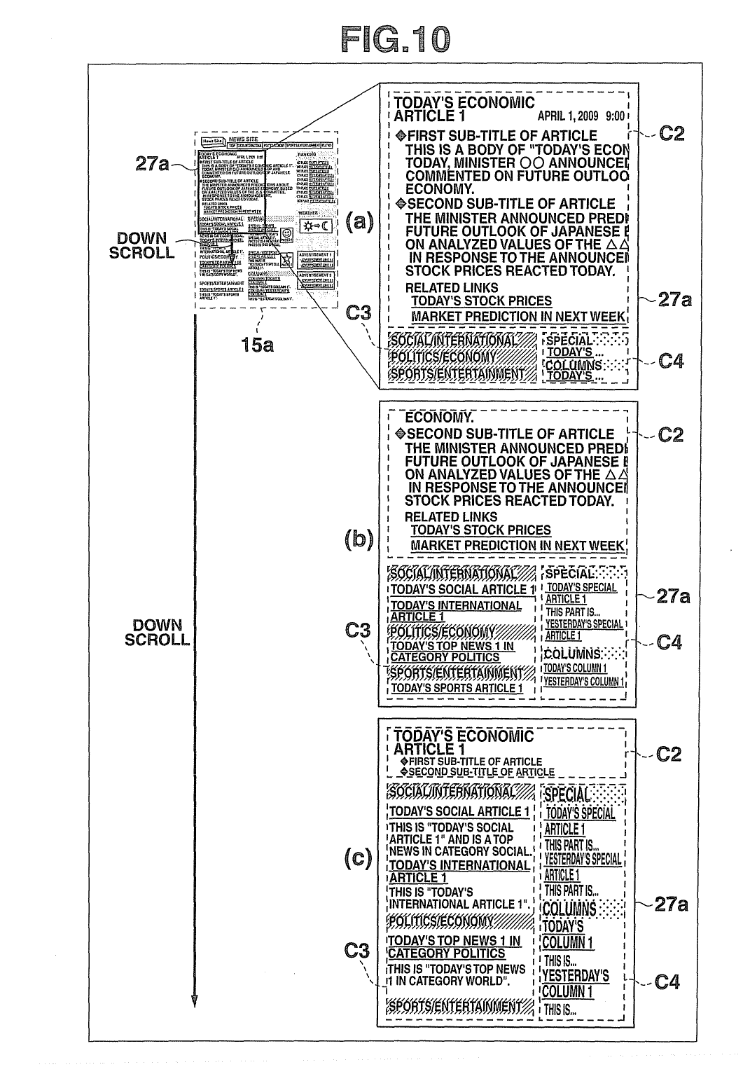

FIG. 10 illustrates an example of transition of the screen where the “font size reduction” UI is employed as the preview UI.

In this “font size reduction” UI, as illustrated by a state (a) in FIG. 10, preview-summary content items are displayed with font sizes reduced. Text is displayed so as not to overflow out of display areas of columns (columns C3 and C4 in this example). In this example, the summarization method based on the “extraction depending on text strength” for column summaries is used. Of course, this preview UI is capable of displaying all types of preview-summary content items represented in FIG. 6A.

In the state (a) of FIG. 10, when the user carries out a user manipulation such as a scroll manipulation or a zoom manipulation to increase a display area of a corresponding column in the display range 27a, a rating of column summarization is decreased, and the column summaries are substituted with preview-summary content items which more resemble original content items, as illustrated by a state (b) in FIG. 10. Alternatively, size reduction of fonts is loosened to display column summaries with larger fonts.

Further, if the display area of a corresponding column (column C3 in this case) in the display range 27a is increased to be greater than a threshold, display of summaries is switched to original display as represented by a state (c) in FIG. 10. Further, a column (column C1 in this case) whose display area is decreased to be less than or equal to the threshold is switched from original display to display of preview-summary content items.

FIG. 11 illustrates an example of screen transition where the “thumbnail size reduction” UI is employed as the preview UI. In this “thumbnail size reduction” UI, as represented by a state (a) in FIG. 11, thumbnail images of preview-summary content items of columns are displayed in respectively corresponding display areas, for example, by changing size reduction rates or aspect ratios so as to fit display areas of corresponding columns (columns C3 and C4 in this example) in the display range 27a. In this example, the summarization method based on “whole text (unchanged)” is used without summaries, and aspect ratios of thumbnails are variable.

Also in this case, the user carries out a user manipulation such as a scroll manipulation or a zoom manipulation, and the size reduction rates and aspect ratios are automatically changed in accordance with increase/decrease of display areas of corresponding columns in the display range 27a. For example, if display areas increase, a magnified display is performed as represented by a state (b) in FIG. 11. In addition, ratings of column summarization of preview-summary content items may be appropriately changed.

Further, if a display area of a corresponding column (column C3 in this case) in the display range 27a is increased to be greater than a threshold, display of summaries is switched to original display as represented by a state (c) in FIG. 11. Further, a column (column C1 in this case) whose display area is decreased to be less than or equal to the threshold is switched from an original display image to display of preview-summary content items.

If an aspect ratio is extremely changed, a corresponding column is hard to view. Therefore, an upper limit may be set to a change to aspect ratios, or columns may be displayed with top and bottom margins or left and right margins added without changing aspect ratios at all.

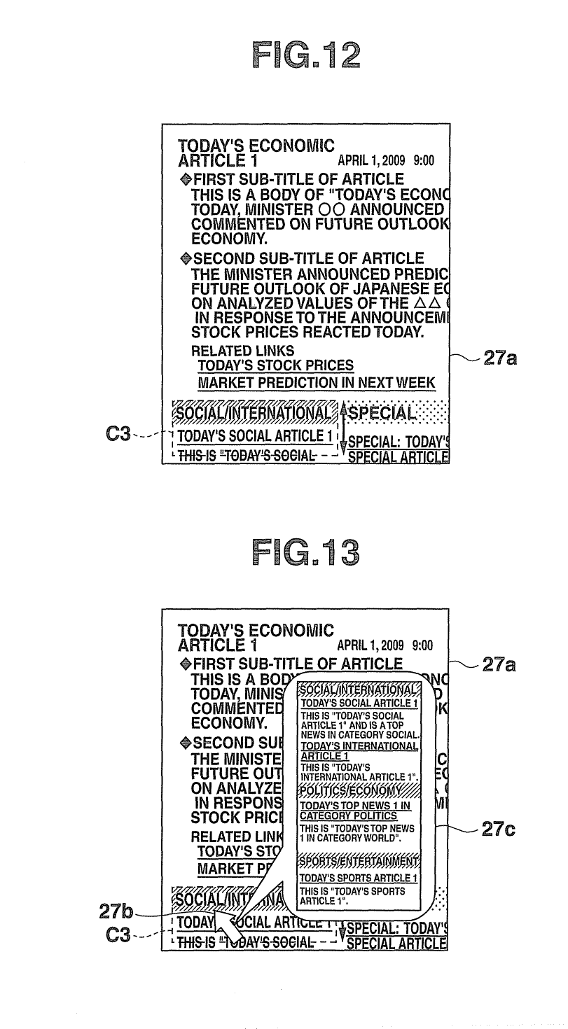

FIG. 12 illustrates an example of screen transition where the “automatic scrolling” UI is employed as the preview UI. In this “automatic scrolling” UI, preview-summary content items of columns are automatically scrolled repeatedly within corresponding display areas of the columns in the display range 27a. Specifically, in a display range denoted by a bidirectional arrow in FIG. 12, display is performed in a manner that preview-summary content items of a corresponding column (column C3 in this case) are automatically scrolled down from a top end. When the scroll range reaches to a bottom end, the content items are then scrolled down again from the top end. This preview UI is also capable of displaying any type of preview-summary content items represented in FIG. 6A.

Further, although the “marquee” UI or “divisional slide show” UI as a preview UI are not particularly illustrated, no scroll is performed but preview-summary content items are divided for every number of lines which can fit in a display area of a corresponding column in the display range 27a. The divided summary content items are moved by a marquee function, i.e., horizontal scrolling, or are automatically switched one after another like a slide show. The aforementioned “marquee” is used to mean a display scroll in which web display content items are moved in horizontal directions in the present specification.

In both types of the preview UIs of the “scroll/slide” UI, if a display area of a column is increased to be greater than a threshold, display of a column summary thereof is switched to original display as in the foregoing case of “size reduction”.

FIG. 13 illustrates an example of screen transition where the “balloon” UI is employed as the preview UI. In this “balloon” UI, a thumbnail image of preview-summary content items of a column is displayed in form of a balloon 27c at a timing when a mouse pointer 27b is on the column or when an unillustrated balloon button is pressed. This preview UI is also capable of displaying any type of preview-summary content items represented in FIG. 6A.

For example, if a column to be displayed in form of a balloon is very large or if the area of the balloon 27c is requested to be small, ratings of summarization of summary content items may be adjusted in accordance with such requests.

Otherwise, if the “no process” UI is used as the preview UI, preview-summary content items of columns are displayed maintaining original font sizes without size reduction. However, not absolutely all processing is undone, and ratings of summarization are adjusted in accordance with increase/decrease of display areas of columns.

Also in this case, if the display area of a column is increased to be greater than a threshold, display of a summary is switched to original display.

This preview UI is capable of displaying all types of preview-summary content items represented in FIG. 6A, too.

Preferably, the user is allowed to appropriately select which of the types of preview UIs represented in FIG. 6B is used to present preview-summary content items to the user. However, a preview UI of one type may be fixedly used, or not all but several types of preview UIs may be selectable.

Next, operations of the client device 20 for performing the foregoing display of preview-summary content items will be described in details below.

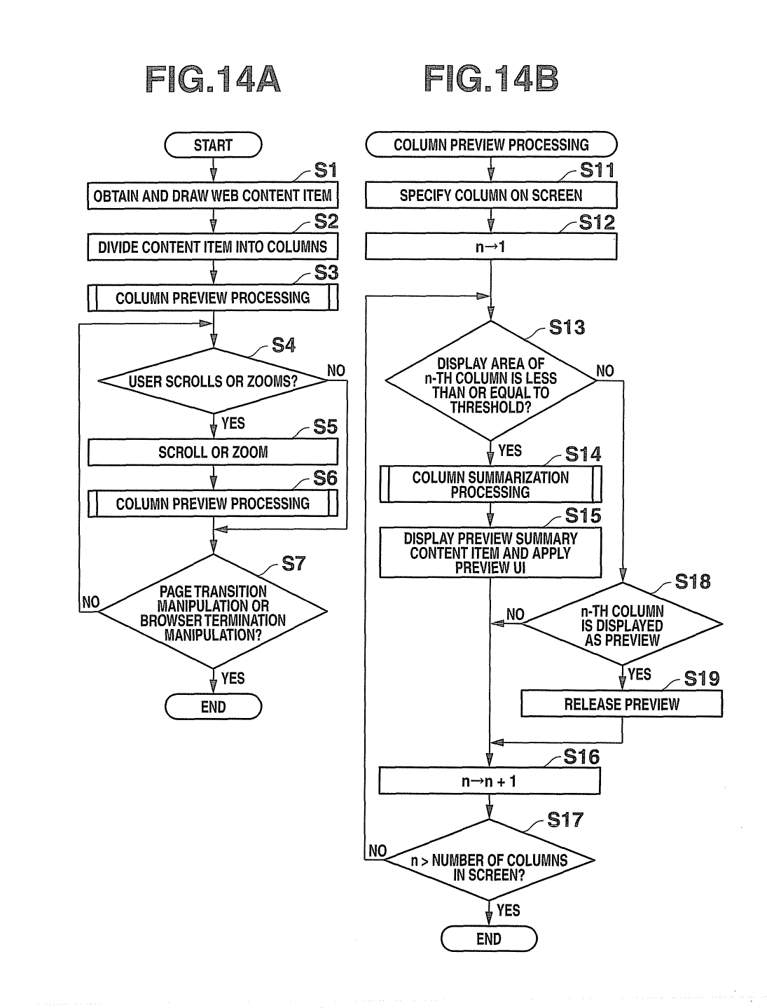

FIG. 14A represents a main processing flowchart of the web browser program 23a in the client device 20.

In accordance with a user manipulation, the web browser program 23a stored in the ROM 23 is started. Then, a web content item 15a distributed by a server device 10 of a web site specified by the user is received and obtained. A source structure of HTML of the web content item 15a is analyzed and is drawn on a frame buffer (unillustrated) in the RAM 24 (step S1) Further, this processing is triggered not only by a browser startup manipulation but also by a user manipulation for reading a new web page, such as a click on a link.

The same processing as performed in ordinary browsers is performed up to this processing. In ordinary browsers, as represented in FIG. 5, the web content item 15a drawn on the frame buffer in the RAM 24 is displayed in the display range 27a of a browser window which is determined, based on prestored hardware information of the display device 27 of the client device 20, and on information of a present display mode such as a magnification rate.

In contrast, in the present embodiment, a column-preview control processing is further executed.

By using existing algorithms employed as functions in a number of browsers for mobile terminals, such as Opera (registered trademark) and NetFront (registered trademark), the web content item 15a drawn on the frame buffer in the RAM 24 is divided into columns (step S2).

Further, columns which are displayed in the display range 27a of the browser window and have insufficient display volumes are determined, and a preview processing is performed on the columns (step S3). In this manner, display of preview-summary content items is performed as described previously. Details of the preview processing will be described later.

Thereafter, whether scrolling or zooming according to a user manipulation has been performed or not is determined (step S4). If such a user manipulation is determined to have been made, scrolling and zooming according to the user manipulation is performed (step S5). Further, each time when a display volume of any of columns in the display range 27a varies, the preview processing is performed again on the columns (step S6).

Thereafter or in step S4 described above, if no user manipulation for scrolling or zooming is determined to have been made, whether transition to another web page or termination of the browser has been commanded by a user manipulation or not is determined (step S7). Here, if a user manipulation which commands transition to another web page or termination of the browser is determined to have not been made, the processing flow returns to step S4 and repeats the operations described above.

Then, if a user manipulation which commands transition to another web page or termination of the browser is determined to have been made, the processing flow is terminated.

FIG. 14B is a flowchart representing details of the preview processing for columns which is performed in step S3 or step S6 described above.

At first, all columns existing in the display range 27a of the browser window or, namely, in the screen are specified (step S11).

Further, the preview processing is performed individually on each of all the columns. Therefore, at first, “1” is set in a counter n provided in the memory (RAM 24) for counting a number of processed columns (step S12). Thereafter, whether the display area of an n-th column as a processing target is less than or equal to a preview threshold or not is determined (step S13).

Here, if the display area of the column as a processing target is determined to be less than or equal to the preview threshold, a column summarization processing is performed to generate preview-summary content items so as to fit in the display area of the column (step S14). Details of the column summarization processing will be described later. Further, the generated preview-summary content items are displayed in the column display area, and are applied with any of the types of the preview UIs represented in FIG. 6B (step S15). Thereafter, the counter n is incremented by “+1” (step S16), and whether an incremented result exceeds the number of columns existing in the screen or not is determined (step S17). Further, if the number of columns is not yet exceeded, an unprocessed column is considered to still remain, and the processing flow returns to step S13 described above. Then, processing is performed on a next column.

Otherwise, if the display area of the column as a processing target is determined to exceed the preview threshold in step S13, whether the column is in a state of displaying preview-summary content items or not is determined (step S18). Here, if the column is determined to be not in the state of displaying preview-summary content items but in a state of displaying an original display image, the processing flows goes to step S16 described above. Otherwise, if the column is determined to be in the state of displaying preview-summary content items, the preview processing for the column is released, i.e., display of preview-summary content items is switched back to display of an original display image (step S19). The processing flow then goes to step S16 described above.

Thus, processing is completed for all the columns existing in the display range 27a of the browser window or, namely, in the screen. Then, the counter n has a value of “the number of all the columns+1”. Accordingly, the value of the counter n is determined to exceed the number of columns existing in the screen in step S17 described above, and the preview processing for the columns is terminated.

The column summarization processing which is performed in step S14 described above is a processing for generating preview-summary content items by summarizing columns in accordance with any of the methods represented in FIG. 6A. Hereinafter, two examples of text summarization based on the “extraction depending on text strength” and “updated part extraction” will be described. For text summarization based on the “summarization (outlining) in ordinary meaning”, existing techniques may be used. Use of the “whole text” requires no special processing, and therefore, descriptions thereof will be omitted herefrom.

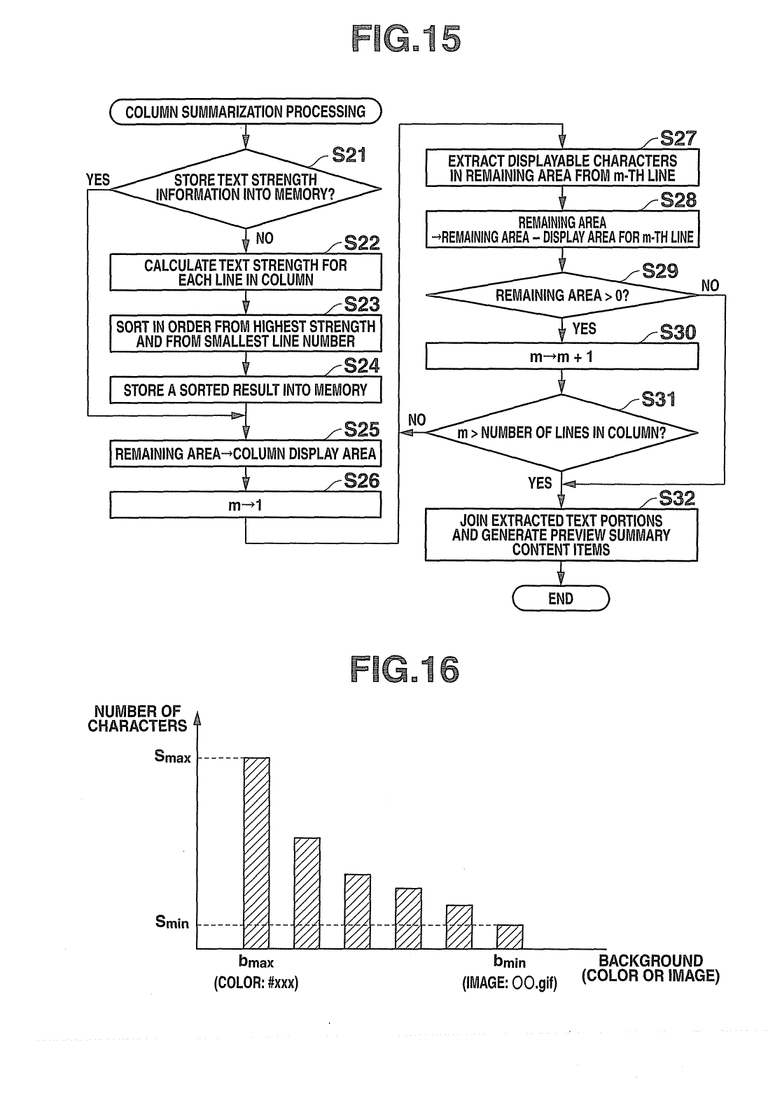

FIG. 15 is a flowchart of the column summarization processing when preview-summary content items are generated by the “extraction depending on text strength”. This processing is to practice the method for extracting only important parts of a column by calculating a text strength for each line in the column and extracting stronger (more outstanding) text prioritized, as in the example of screen represented in FIG. 7.

That is, at first, whether text strengths have been calculated for a presently processed column and have been stored in the memory (RAM 24) or not is checked (step S21). This check always results in NO in the summarization processing for the first time. If text strengths have been calculated, calculation results for a previous time are reused intactly. The processing flow therefore goes to step S25 described later.

If text strengths are determined to have not yet been calculated, the column is divided into lines, and a text strength is calculated for each of the lines (step S22). Details of the calculation of text strengths will be described later. Next, lines are sorted in an order from the greatest calculated strength and from the smallest line number (positioned highest in the column) (step S23), and a sorted result is stored into the memory (step S24).

Next, a remaining area counter provided in the memory (RAM 24) is initialized to a value of a column display area (step S25). Further, “1” is set in a counter m provided in the memory (RAM 24) for counting a number of processed lines (step S26). Thereafter, the m-th line is extracted from lines sorted in the order from the greatest text strength and from the smallest line number. A number of characters which can be displayed in a remaining area indicated by a value of the remaining area counter are extracted from the m-th line. That is, the greatest number of characters which are allowed to be displayed in the remaining area are extracted (step S27). The extracted characters are stored into the memory. Since the remaining area is reduced by the extraction as described above, a display area for the m-th line is subtracted from the value of the remaining area counter (step S28).

Thereafter, whether the remaining area indicated by the remaining area counter is greater than zero or not is determined (step S29). If the remaining area is determined to be still greater than zero, the counter m is incremented by “+1” (step S30), and whether the incremented result exceeds the number of lines in the column or not is determined (step S31). Further, if the number of lines in the column is not yet exceeded, any unprocessed line is considered to still remain, and the processing flow returns to step S13 described above. Then, processing is performed on a next line.

In this manner, if the remaining area is determined to be less than or equal to zero in step S29 described above or if the value of the counter m is determined to exceed the number of lines in the column in step S31 described above, i.e., if all the lines in the column are determined to have been processed, all text portions which have been extracted as characters in step S27 described above and stored into the memory are joined together to generate preview-summary content items (step S32). The column summarization processing is then terminated.

Each of the extracted text portions is arranged to maintain the same style as that in original display unless a style change (such as font size reduction) is made to the preview UI. Accordingly, the extracted text portions may not look much different from original display.

Further, in the flowchart in FIG. 15, lines having an equal text strength are extracted in an order from one positioned higher. In cases, lines positioned lower are not displayed at all. Hence, if a remaining area is insufficient for lines having strengths of an equal level and if all text in all lines cannot be displayed, a number of characters to be extracted from each line may be determined to be equally distributed so that line heads of all the lines are extracted and displayed. In this method, all lines can be viewed although tail ends of lines may be omitted. Therefore, even when an important content item is positioned lower, at least a line head of the important content item comes into sight of the user.

Next, the text strength calculated for each line in step S22 described above will be described.

The “text strength for each line” is a total of strength points which are respectively calculated for style information items such as “font size”, “font weight (boldness)”, and “background”.

That is, as values of the font size and font weight increase, text characters themselves becomes more outstanding. Further, there is a popular design method for web sites, in which a visual sectioning is added by changing only a background for one line, to make this line outstanding. For such an line containing outstanding text, a calculation method is determined so as to increase the text strength.

The calculation method described the embodiment is merely an example. Any calculation method may be employed insofar as the calculation method complies with a basic concept of “specifying outstanding important text”.

For an index such as a font sizes or font weight which indicates more outstanding text as values of styles increase, at first, a minimum value fmin and a maximum value fmax of the index which can be taken by text within a column are obtained. Further, normalization is performed so that the minimum value fmin of the index becomes zero points and the maximum value fmax becomes 100 points. A most frequent value f among indices in a line is taken as a representative value. On this condition, a strength point SP is calculated by an equation (1) below:

SP={(f−fmin)/(fmax−fmin)}*100 (1)

Specifically, when a strength is calculated for each line, a most frequent value f of font sizes (or weights) in a line is taken as a representative value, and a value obtained by the foregoing equation is the value of strength points for the font size (or weight).

Alternatively, for an index such as for a background which is stronger as the background appears less frequently, at first, a total of characters is calculated for each value of the index.

FIG. 16 is a graph representing an example of results of calculating a total of characters for each background in a column. This graph represents results of calculating a total of characters s for each background in a column, e.g., a number of characters having a background color #xxx, and a number of characters given a background image oo.gif.

Further, normalization is performed in a manner that a most frequent background which is applied to the greatest number of characters is given zero points, and a least frequent background is given 100 points. Where a total of characters the line is s, a maximum number of characters per line in a column is smax, and a minimum number of characters per line is smin, background strength point BSP is calculated by an equation (2) below:

BSP={(s−smin)/(smax−smin)}*100 (2)

That is, the smaller the number of characters is, the greater the points are.

Further, text strength point TSP as total point considering all of the strength points respectively for the font size (SSP), font weight (WSP), and background (BSP) can be calculated by adding weights through an equation (3) below:

$$TSP = weight fs * SSP + weight fw * WSP + weight bg * BSP \qquad ( 3 )$$

Strengths of individual indices are normalized to 10 to 100 points. However, whether text is outstanding or not more depends on font weights or backgrounds than on font sizes. Hence, an adjustment is made by individually adding weights.

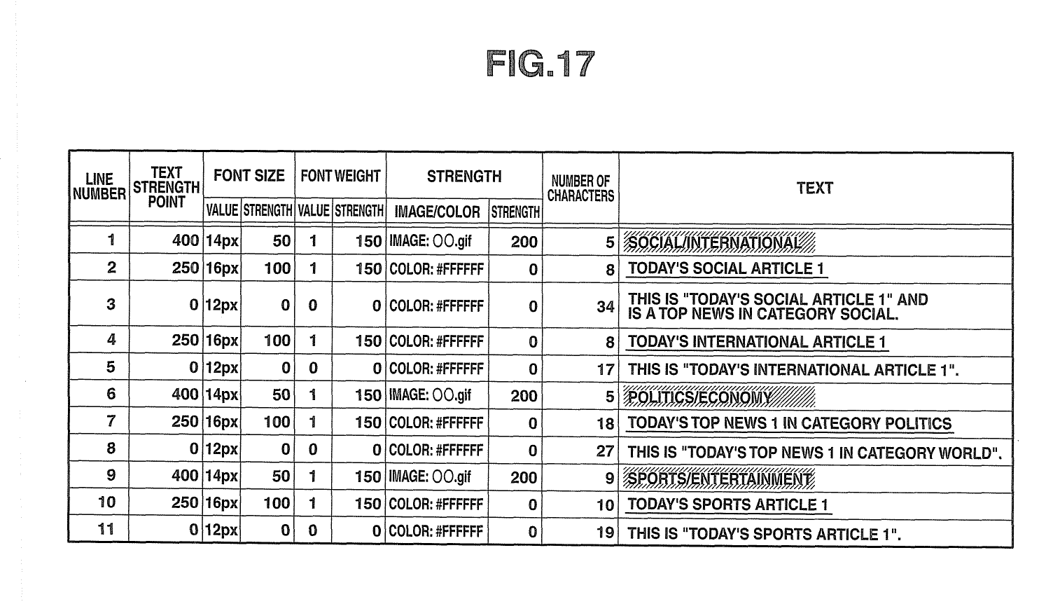

FIG. 17 is a table representing an example of text strengths for each of lines calculated by the calculation equation described above.

This is an example in which column C3 in FIG. 4 is dealt with as a material. Further, the weight fs for font sizes is “1”, the weight fw for font weights is “1.5”, as well as the weight bg for backgrounds is “2”.

In this example, text strength point of a title (“social/international”) indicating a name of category is the highest (400 points), and text strength points of an article title in the category is second highest (250 points). The lowest point (zero points) is a caption appended below an article title.

Thus, text strengths are determined so as to increase in an order from the most outstanding line.

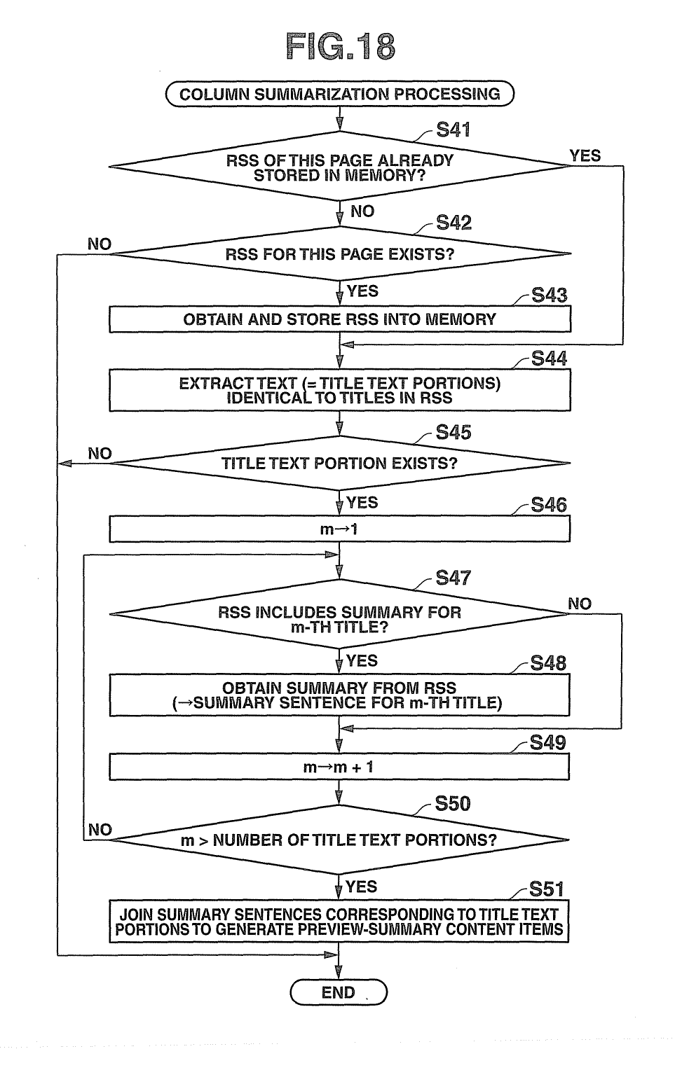

FIG. 18 is a flowchart of the column summarization processing when preview-summary content items are generated by the “updated part extraction”. This processing is to practice a method, a screen example of which has been cited in FIG. 9, for extracting only recently updated parts from columns, to form the extracted updated parts as preview-summary content items of the columns.

Specifically, at first, whether an RSS associated with a web content item 15a in a presently processed web page has already been obtained and stored into the memory (RAM 24) or not is checked (step S41). This check always results in NO in the summarization processing which is performed for the first time. If already obtained, a previously obtained RSS is reused intactly. The processing flow therefore goes to step S44 described later.

If such an RSS is determined to have not yet been obtained, whether an RSS associated with the web content item 15a in the web page exists or not is checked (step S42). Here, if such an RSS is determined to not exist, summarization cannot be performed in this method, and preview-summary content items are left vacant. The column summarization processing is then terminated.

Otherwise, if such an RSS is determined to exist, the RSS is newly obtained and stored into the memory so as to be usable later in the processing for the next time (step S43).

Further, text portions identical to titles included in update information in the RSS are searched for, extracted, and stored into the memory from text in the web content item 15a in the web page (step S44). The identical text portions will be hereinafter referred to as title text portions. Further, whether such title text portions exist or not is determined (step S45). If no title text portion exists, there is no updated part in corresponding columns. Therefore, preview-summary content items are left vacant, and the column summarization processing is terminated.

If such title text portions are determined to exit, summary sentences are respectively obtained for the title text portions if summary sentences are included in the RSS. Therefore, at first, “1” is set in the counter m provided in the memory (RAM 24) for counting a number of processed title text portions (step S46). Thereafter, whether a summary corresponding to the m-th title text portion exists in the RSS or not is determined (step S47). If no corresponding summary exists, the processing flow goes to step S49 describe later. Otherwise, if a corresponding summary exists, the summary is obtained from the RSS and is stored as a summary sentence for the m-th title text into the memory (step S48). Further, the counter m is incremented by “+1” (step S49), and whether an incremented result exceeds the number of title text portions or not is determined (step S50). If not yet exceeded, an unprocessed title is considered to still exist. Therefore, the processing flow returns to the step S47 described above, and processing is performed on a next title text.

Thus, if the counter m is determined in step S50 above to have exceeded the number of title text portions, i.e., the processing is determined to have been made on all title text portions, all the title text portions stored in the memory and the summary sentences for corresponding titles obtained from the RSS are respectively coupled with each other orderly, thereby to generate preview-summary content items (step S51). Then, the column summarization processing is terminated.

In generation of preview-summary content items in step S51 described above, summary sentences for titles obtained from the RSS are located to be added below respectively corresponding title text portions.

Each title text portion is configured to maintain the same style as that in original display unless a style change (such as font size reduction) is made to the preview UI. Accordingly, extracted text may not much look different from original display.

In addition, preview-summary content items are inevitably left vacant in some cases, such as when no RSS is determined to exist in step S42 described above or when no updated part is determined to exist in a column in step S47. In such cases, only for a corresponding column or columns, preview-summary content items may be generated by another type of method among those represented in FIG. 6A.

As has been described above, in a server-client system according the embodiment of the information processing device according to the present invention, a web content item 15a is divided in units of columns on a display of a web page on a browser. If display areas of columns presently appearing in a display range 27a of a browser window are insufficient, preview-summary content items which are summaries of content items in the columns are created and displayed in corresponding parts of the display areas. Further, display is performed in a display method added with a preview UI based on font size reduction and/or automatic scrolling, thereby to compensate for insufficiency of the display areas. Therefore, even when viewability at a glance is poor such as when zooming in into a small screen, what content items are contained in columns located at ends of the screen can be schematically understood. The user therefore can greatly save labor of wastefully scrolling columns only to simply check content of the columns. Accordingly, the user can enjoy more comfortable web browsing. That is, the information processing device according to the embodiment allows easy understanding of summaries of content of columns in web content items by reducing complex manipulations and particularly improves convenience of browsing web content items by mobile terminals using a small screen also by reducing complex manipulations. At what rating a column is summarized (into a short or long summary) is automatically adjusted depending on a display area of the column.

Further, if a display area of a column is changed by scrolling or zooming, preview-summary content items are created automatically adjusting summarization ratings, such as summaries extracted prioritizing greater text strengths, summaries extracted updated parts, and summaries in ordinary meaning. Therefore, display suitable for display areas can be achieved, and display can be more similar to original display in accordance with increase of a display area. Accordingly, a limited screen space can be used effectively so as to match a display state on time.

Further, even when a display area of a column is too small to sufficiently display summaries, the summaries can be sufficiently displayed after scrolling the column only several times. Accordingly, the user can understand content of the column to distinguish interesting information for the user by fewer scrolls than in ordinary display (of not presenting summaries).

Further, when preview-summary content items are generated, text extracted for summaries are displayed in the same style, for example, with the same fonts/backgrounds, as those in original display unless a request such as font size reduction is issued to a preview UI. The outer appearances of summary content items do not look different from but are visually integrated with original display. The user can therefore enjoy web browsing without being worried if “a background color has suddenly changed after scrolling” or “a display style has absolutely changed after zooming out from a state of reduced font sizes, and what part is displayed cannot be understood”.

Further, smallness of a display area can be compensated for by displaying a preview by incorporating any of font size reduction, thumbnail size reduction, automatic scrolling, marquee, divisional slide show, and balloon thumbnails. Further, if the user is allowed to select appropriately what type of preview UI is to be added, display in a display format which the user feels most comfortable to see with can be achieved.

The above embodiment has been described where a content 15a in a web site specified by the user is obtained and subjected to display controls by building the column preview control function described above into the web browser program 23a of a client device 20 in an ordinary server-client system. In contrast, when a content 15a in a web site specified by the user is obtained and displayed by a thin client terminal in a server-based computing system (SBC), the same column preview control function as described above may be built in a web browser of the server which is started up by an input event from the thin client terminal.

Each of methods of the processing employed in the information processing device, as described in the above embodiment, i.e., the processing represented in the flowcharts in FIGS. 14, 15, and 18 can be distributed as a program which is executable from a computer and is stored in a medium for the external storage device 25 (15), such as a memory card (e.g., a ROM or RAM card), a magnetic disc (e.g., a floppy or hard disc), an optical disc (e.g., CD-ROM or DVD), or a semiconductor memory. Further, the computer (CPU 21 (11)) in the information processing devices realizes the column preview control function described in the above embodiment and can execute the same methods for the processing as described above, by reading the program stored in a medium for the external storage device 25 (15), into the storage device (flash ROM 23(13) or RAM 24(14)), and by controlling operations in accordance with the read program.

Further, data of the aforementioned program for realizing the also aforementioned methods can be transferred in form of program codes through the communication network (N). The data of the program can be loaded from a computer device (program server) connected to the communication network (N). The data can further be stored into the storage device (flash ROM 23(13) or RAM 24(14)), and can then be used to realize the column preview control function.

The invention of the present application is not limited to the embodiment described above but can be variously modified in practical phases without deviating from a scope of the subject matter of the invention. Further, the embodiment includes inventions of various phases, and various inventions can further be derived from appropriate combinations of plural constitutive elements disclosed.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An information processing device comprising:
a web content receiver module configured to receive a web content item;
a display module configured to expand and display the received web content item into a web page;
a column extraction module configured to analyze the received web content item and extract columns respectively as constitutive units forming a layout of the web page;
a determination module configured to compare each of display areas of the columns with a threshold, in a display state of the web page by the display module, and thereby determine whether each of the display areas is sufficient or not;
a summarization module configured to, if the display area of any of the columns is not sufficient as a result determined by the determination module, summarize content of the any of the columns, depending on the display area; and
a preview display module configured to, if the display area of any of the columns is not sufficient as a result determined by the determination module, adapt summarized content of the any of the column into a preview display format depending on the display area, and display the adapted content on the display module.

2. The information processing device according to claim 1, wherein the summarization module performs summarization, prioritizing columns having a greater text strength.

3. The information processing device according to claim 1, wherein the summarization module performs summarization to form an outline of sentences.

4. The information processing device according to claim 1, wherein the preview display module displays previews with font sizes reduced.

5. The information processing device according to claim 1, wherein the preview display module displays thumbnails reduced in size.

6. The information processing device according to claim 1, wherein the preview display module displays a preview automatically scrolled.

7. The information processing device according to claim 1, wherein the preview display module displays a preview added with a marquee.

8. The information processing device according to claim 1, wherein the preview display module displays a preview in form of a divisional slide show.

9. The information processing device according to claim 1, wherein the preview display module displays a preview as a ballooning thumbnail.

10. An information processing device comprising:
a web content receiver module configured to receive a web content item;
a display module configured to expand and display the received web content item into a web page;
a column extraction module configured to analyze the received web content item and extract columns respectively as constitutive units forming a layout of the web page;
a determination module configured to compare display each of display areas of the columns with a threshold, in a display state of the web page by the display module, and thereby determine whether each of the display areas is sufficient or not;
a summary obtaining module configured to, if the display area of any of the columns is not sufficient as a result determined by the determination module, obtain a summary sentence of an updated part of the any of the columns; and
a preview display module configured to, if the display area of any of the columns is not sufficient as a result determined by the determination module, adapt content of the summary sentence into a preview display format depending on the display area, and display the adapted content on the display module.

11. The information processing device according to claim 10, wherein the preview display module displays previews with font sizes reduced.

12. The information processing device according to claim 10, wherein the preview display module displays thumbnails reduced in size.

13. The information processing device according to claim 10, wherein the preview display module displays a preview automatically scrolled.

14. The information processing device according to claim 10, wherein the preview display module displays a preview added with a marquee.

15. The information processing device according to claim 10, wherein the preview display module displays a preview in form of a divisional slide show.

16. The information processing device according to claim 10, wherein the preview display module displays a preview as a ballooning thumbnail.

17. A non-transitory recording medium which records a program for controlling a computer of an information processing device comprising a display section, the program causing the computer to function as:
a web content receiver module configured to receive a web content item;
a display module configured to expand and display the received web content item into a web page;
a column extraction module configured to analyze the received web content item and extract columns respectively as constitutional units forming a layout of the web page;
a determination module configured to compare display each of display areas of the columns with a threshold, in a display state of the web page by the display module, and thereby determine whether each of the display areas is sufficient or not;
a summarization module configured to, if the display area of any of the columns is not sufficient as a result determined by the determination module, summarize content of the any of the columns, depending on the display area; and
a preview display module configured to, if the display area of any of the columns is not sufficient as a result determined by the determination module, adapt summarized content of the any of the column into a preview display format depending on the display area, and display the adapted content on the display module.
